(19) United States
(12) Patent Application Publication
(10) Pub. No.: US 2026/0081372 A1
(43) Pub. Date: Mar. 19, 2026

(54) CIRCUIT TERMINAL CONTACTS WITH SNAP AND LOCK ELEMENTS

(71) Applicant: HONEYWELL INTERNATIONAL INC., Charlotte, NC (US)

(72) Inventors: Gangaraju, Charlotte, NC (US); Basavaraja TELI, Charlotte, NC (US)

(21) Appl. No.: 19/321,971

(22) Filed: Sep. 8, 2025

(30) Foreign Application Priority Data
Sep. 19, 2024 (IN) 202411070840

(51) Int. Cl. H01R 12/58

(52) U.S. Cl. CPC H01R 12/585

(57) ABSTRACT

A terminal contact comprising a shaft; a first interface at a first end of the shaft, the first interface comprising an eye of needle, a first anchor element, and a second anchor element; and a second interface at an intermediate portion of the shaft, the second interface comprising a third anchor element and a fourth anchor element.

### CROSS-REFERENCE TO RELATED APPLICATION

This application claims priority pursuant to 35 U.S.C. 119(a) to Indian Application No. 202411070840, filed Sep. 19, 2024, which application is incorporated herein by reference in its entirety.

### TECHNICAL FIELD

Various embodiments of the present disclosure relate to circuit terminals, and more particularly to terminal contacts that provide mechanical locking onto a printed circuit board assembly and a housing.

### BACKGROUND

Certain devices, such as current sensors, may comprise complex terminal contact design profiles that are difficult to position during insert molding of associated device housings. Terminal contacts also comprise individual elements that are time consuming to load into insert molding tools. Alternatively, a connector carrier may be molded separately from the terminal contacts and assembled with the terminal contacts to the printed circuit board assembly via compliant pin elements. However, positioning the terminal contacts with the printed circuit board assembly using the compliant fin elements may be challenging and require a manual process or use of an external fixture. Moreover, some conventional terminal contacts may comprise flat or round profiles that are soldered for coupling with printed circuit board assemblies. However, soldering is an operator dependent process that may vary in quality and thereby adds to manufacturing costs.

Applicant has identified many technical challenges and difficulties associated with designing terminal contacts for various printed circuit board assembly and housing configurations.

### BRIEF SUMMARY

Various embodiments described herein relate to circuit terminals. In accordance with various embodiments of the present disclosure, terminal contact is provided. In some embodiments, the terminal contact comprises a shaft; a first interface at the first end of the shaft, the first interface comprising an eye of needle, a first anchor element, and a second anchor element; and a second interface at an intermediate portion of the shaft, the second interface comprising a third anchor element and a fourth anchor element.

In some embodiments, the first interface is configured with a printed circuit board assembly. In some embodiments, the eye of needle comprises two sidewalls that are compressible. In some embodiments, at least one of the first anchor element or the second anchor element comprises a barb including an inclined plane shape. In some embodiments, the first anchor element comprises a first barb that (i) allows for passing through an aperture from a first end of the first barb in a first direction that is along a plane of the first interface and (ii) prevents passing through the aperture at a second end of the first barb in a second direction along the plane of the first interface. In some embodiments, the second anchor element comprises a second barb that prevents passing through the aperture at a first end of the second barb in the first direction along the plane of the first interface. In some embodiments, the third anchor element comprises a barbed appendage that (i) is located on the first side of the shaft and (ii) comprises a shape that is arched towards a first direction away from a plane of the second interface. In some embodiments, the fourth anchor element comprises a barbed appendage that (i) is located on a second side of the shaft that is opposite of the first side and (ii) comprises a shape that is arched towards a second direction away from the plane of the second interface.

In some embodiments, the second interface is configured with a female element of a housing connector carrier. In some embodiments, the second interface is configured with the female element by (i) inserting a second end of the shaft that is opposite of the first end into the female element and (ii) passing the third anchor element and the fourth anchor element through the female element. In some embodiments, the third anchor element and the fourth anchor element comprise locating elements for desired positioning of the shaft with respect to a female element. In some embodiments, the female element comprises an anchor slot that is configured to receive the third anchor element and the fourth anchor element. In some embodiments, the third anchor element and the fourth anchor element provide locking of the second interface into the anchor slot. In some embodiments, the second interface is deformable for disengagement from the female element. In some embodiments, the first interface provides electrical, signal, and/or data connectivity to a printed circuit board assembly.

The foregoing illustrative summary, as well as other exemplary objectives and/or advantages of the disclosure, and the manner in which the same are accomplished, are further explained in the following detailed description and its accompanying drawings.

### BRIEF DESCRIPTION OF THE DRAWINGS

The description of the illustrative embodiments may be read in conjunction with the accompanying figures. It will be appreciated that, for simplicity and clarity of illustration, elements illustrated in the figures have not necessarily been drawn to scale, unless described otherwise. For example, the dimensions of some of the elements may be exaggerated relative to other elements, unless described otherwise. Embodiments incorporating teachings of the present disclosure are shown and described with respect to the figures presented herein, in which:

FIG. 1 depicts an example electronic device;

FIG. 2 depicts a cross-sectional view of an example electronic device;

FIG. 3 depicts an example terminal contact;

FIG. 4 depicts a cutaway view of at least a portion of an electronic device;

FIG. 5 depicts an example terminal contact in accordance with some embodiments of the present disclosure;

FIG. 6 depicts the first interface 502 of the terminal contact 500 in accordance with some embodiments of the present disclosure;

FIG. 7 depicts the second interface 504 of the terminal contact 500 in accordance with some embodiments of the present disclosure;

FIG. 8 depicts an example housing 800 in accordance with some embodiments of the present disclosure;

FIG. 9 depicts an example configuration of the plurality of terminal contacts 804 within the example housing 800 in accordance with some embodiments of the present disclosure;

FIG. 10 is a zoomed-in view of an example anchor slot 808 in accordance with some embodiments of the present disclosure;

FIG. 11 is a cross-sectional view of an example configuration of a terminal contact 1102 with a PCBA 1104 within an example housing 1100 in accordance with some embodiments of the present disclosure; and,

FIG. 12 depicts an example configuration of the PCBA 1104 with the terminal contact 1102 in accordance with some embodiments of the present disclosure.

### DETAILED DESCRIPTION

Some embodiments of the present disclosure will now be described more fully hereinafter with reference to the accompanying drawings, in which some, but not all embodiments of the disclosure are shown. Indeed, these disclosures may be embodied in many different forms and should not be construed as limited to the embodiments set forth herein; rather, these embodiments are provided so that this disclosure will satisfy applicable legal requirements. Like numbers refer to like elements throughout.

As used herein, terms such as “front,” “rear,” “top,” etc., are used for explanatory purposes in the examples provided below to describe the relative position of certain components or portions of components. Furthermore, as would be evident to one of ordinary skill in the art in light of the present disclosure, the terms “substantially” and “approximately” indicate that the referenced element or associated description is accurate to within applicable engineering tolerances.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration. ” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

As described above, there are many technical challenges and difficulties associated with designing terminal contacts for various printed circuit board assembly and housing configurations. In some embodiments, the term “terminal contact” may describe a conductor that is used to provide an interface for transferring data, power, and/or signals. For example, a plurality of terminal contacts may be coupled to a printed circuit board assembly (PCBA) to provide an electronic interface with one or more external circuits.

FIG. 1 depicts an example electronic device 100. The electronic device 100 comprises a housing 102 and various components within the housing 102.

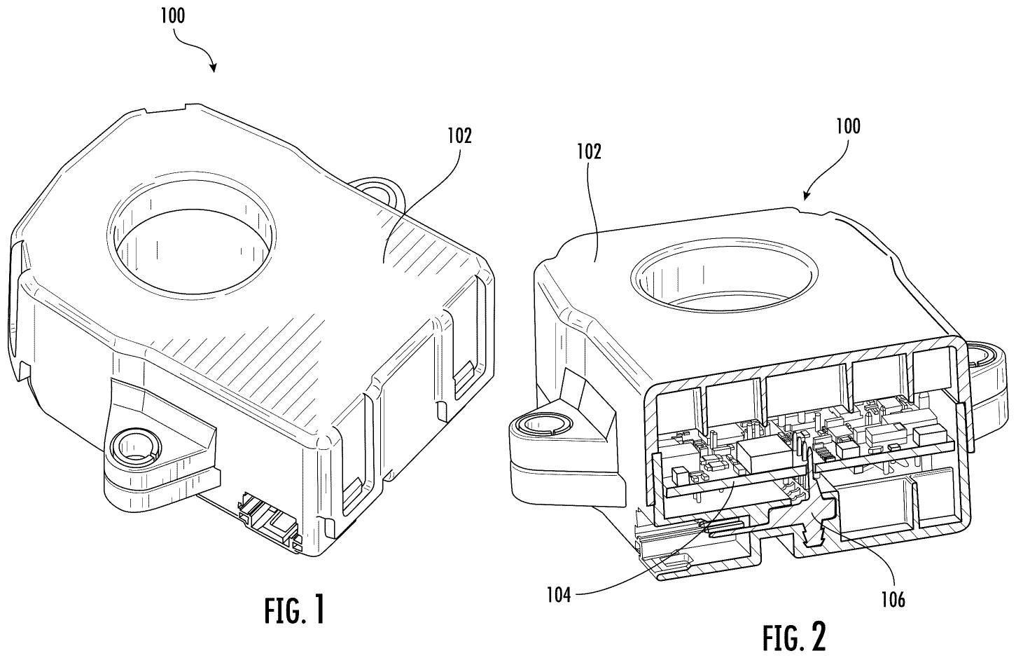

FIG. 2 depicts a cross-sectional view of the example electronic device 100. The electronic device 100 further comprises a printed circuit board assembly (PCBA) 104 that is coupled with a plurality of terminal contacts 106 within the housing 102.

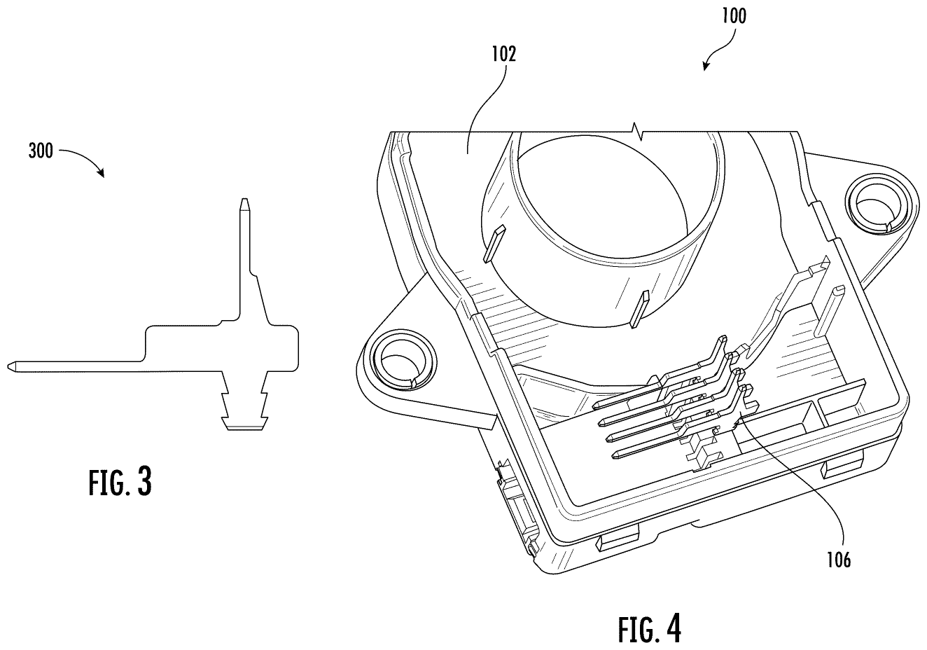

FIG. 3 depicts an example terminal contact 300. The terminal contact 300 is an example one of the plurality of terminal contacts 106.

FIG. 4 depicts a cutaway view of at least a portion of the example electronic device 100. Construction of the electronic device 100 may comprise creating at least a portion of the housing 102 with the plurality of terminal contacts 106 by insert molding. The plurality of terminal contacts 106 may be further soldered to the PCBA 104.

Reliance on insert molding may be associated with several disadvantages. For example, insert molding may create plastic fumes that are harmful if inhaled. Accordingly, proper ventilation may need to be provided for performing insert molding. Aside from health, safety, and environmental concerns, insert molding may also be attributed to higher manufacturing costs.

Soldering may also have similar disadvantages as insert molding where solder fumes may be harmful if inhaled. Additionally, soldering is a precise process that is preferably performed by qualified technicians. The reliability of solder joints may also vary based on operating temperature, humidity, and/or pressure. On average, manual soldering may exhibit approximately 10% of soldering quality issues in manufacturing plants and approximately 5% rejection from customers due to soldering electrical failure. Thus, the use of soldering also contributes to higher manufacturing costs.

Alternatively, construction of the electronic device 100 may comprise creating a mold of a connector carrier that is assembled with the plurality of terminal contacts 106 and the PCBA 104 via compliant pin elements. However, difficulties may arise with pin positioning.

Moreover, the aforementioned construction techniques (e.g., soldering or use of complaint pin elements) do not have a locating element for establishing an electrical connection between the terminal contacts and the PCBA.

Various example embodiments of the present disclosure overcome such technical challenges and difficulties in designing terminal contacts for various printed circuit board assembly and housing configurations and provide various technical advancements and improvements. In accordance with various embodiments of the present disclosure, for example, terminal contacts for improving manufacturing processes of electronic devices are disclosed. Terminal contacts are disclosed for reducing complexity of interfacing with housing designs and PCBAs as well as obviating the need for injection molding and soldering.

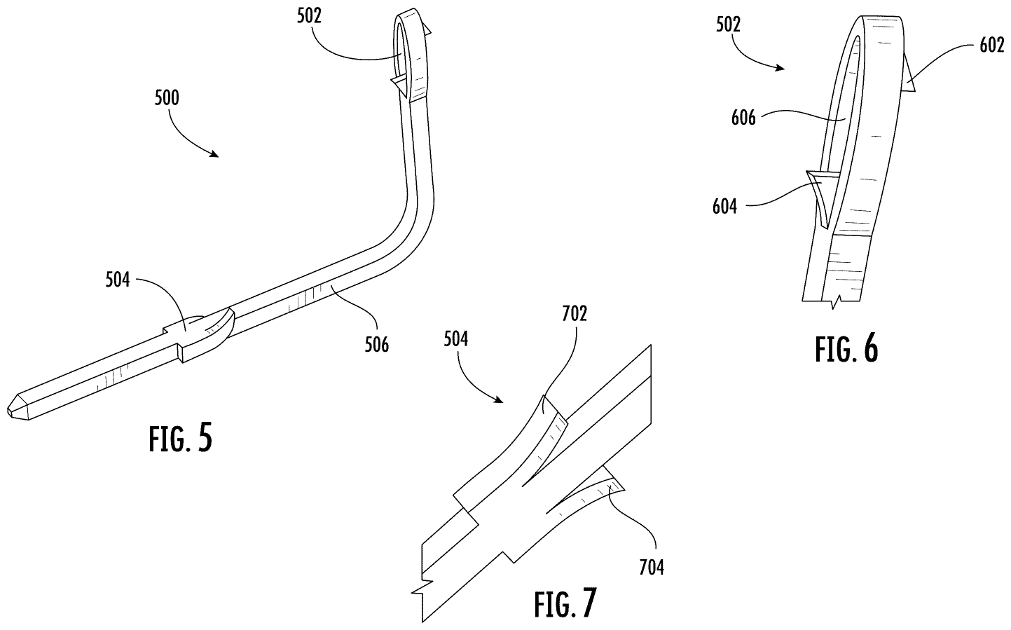

Referring now to FIG. 5, an example terminal contact 500 is depicted in accordance with some embodiments of the present disclosure. The terminal contact 500 comprises a shaft 506 that may be formed or bent into any shape. As depicted in FIG. 5, the shaft 506 is curved into an L shape. The body of the shaft 506, as further depicted in FIG. 5, comprises a rectangular profile, however, the shaft 506 may comprise other geometric or non-geometric shapes. The terminal contact 500 may comprise a conductor material, such as copper, gold, silver, or platinum. The terminal contact 500 further comprises a first interface 502 at a first end of the shaft 506 and a second interface 504 that is positioned at an intermediate portion of the shaft 506. In some embodiments, the first interface 502 may be configured with a PCBA. In some embodiments, the second interface 504 may be configured with a female element of a housing connector carrier.

FIG. 6 depicts the first interface 502 of the terminal contact 500 in accordance with some embodiments of the present disclosure. The first interface 502 comprises two locating mechanism that may be suitable for configuration with a PCBA. The first locating mechanism of the two locating mechanisms may comprise an eye of needle 606 that is formed between two sidewalls of the first interface 502 that are compressible when inserted into an appropriate contact aperture of a PCBA. A second locating mechanism of the two locating mechanisms may comprise a set of anchor elements that includes a first anchor element 602 and a second anchor element 604. Each of the first anchor element 602 and the second anchor element 604 may comprise a barb having an inclined plane shape. In some embodiments, the first anchor element 602 comprises a first barb that allows for passing through an aperture (e.g., of a PCBA) from a first end of the first barb in a first direction (e.g., insertion) along the plane of the first interface 502 and resists or prevents passing through the aperture at a second end of the first barb in a second direction (e.g., removal) along the plane of the first interface 502. In some embodiments, the second anchor element 604 comprises a second barb that prevents passing through the aperture at a first end of the second barb in the first direction along the plane of the first interface 502.

FIG. 7 depicts the second interface 504 of the terminal contact 500 in accordance with some embodiments of the present disclosure. As depicted in FIG. 7, the second interface 504 comprises a third anchor element 702 and a fourth anchor element 704. The third anchor element 702 comprises a barbed appendage that (i) is located on the first side of the shaft 506 and (ii) comprises a shape that is arched towards a first direction away from the plane of the second interface 504. The fourth anchor element 704 comprises a barbed appendage that (i) is located on a second side of the shaft 506 that is opposite of the first side (or the third anchor element 702) and (ii) comprises a shape that is arched towards a second direction away from the plane of the second interface 504 that is opposite of the first direction away from the plane of the second interface 504.

In some example embodiments, the second interface 504 of the terminal contact 500 may be configured with a female element of a housing connector carrier by (i) inserting a second end of the shaft 506 that is opposite of the first interface 502 (at the first end of the shaft) into the female element and (ii) passing the third anchor element 702 and the fourth anchor element 704 through the female element. In some example embodiments, the third anchor element 702 and the fourth anchor element 704 of the second interface 504 may provide locating elements for desired positioning of the shaft 506 with respect to a female element and/or within a housing connector carrier. For example, the female element may comprise an anchor slot for receiving the third anchor element 702 and the fourth anchor element 704. In some embodiments, the third anchor element 702 and the fourth anchor element 704 may be anchored into the anchor slot of the female element upon being received into the anchor slot. Accordingly, the third anchor element 702 and the fourth anchor element 704 provide locking of the second interface 504 into the anchor slot thereby fixing the shaft 506 into a stationary position.

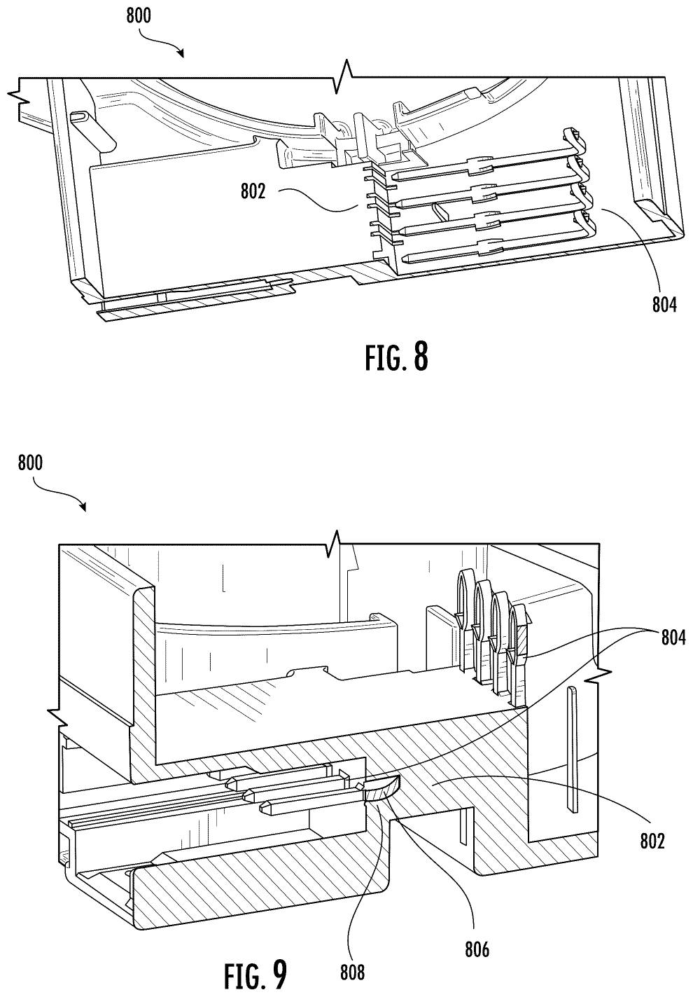

FIG. 8 depicts an example housing 800 in accordance with some embodiments of the present disclosure. The housing 800 comprises a housing connector carrier 802 that comprises a plurality of female elements that may be configured to receive a plurality of terminal contacts 804. The plurality of terminal contacts 804 are examples of the terminal contact 500 of FIG. 5. In some example embodiments, each terminal contact of the plurality of terminal contacts 804 may be inserted into any one of a plurality of female elements of the housing connector carrier 802.

FIG. 9 depicts an example configuration of the plurality of terminal contacts 804 within the example housing 800 in accordance with some embodiments of the present disclosure. As depicted in FIG. 9, the plurality of terminal contacts 804 are inserted into a plurality of female elements of the housing connector carrier 802. Each of the plurality of terminal contacts 804 may comprise an interface 806 (e.g., second interface 504) that includes a pair of anchor elements (e.g., anchor element 702 and anchor element 704) for locating and fixing the terminal contact in a fixed position within a female element of the housing connector carrier 802. As further depicted in FIG. 9, the interface 806 of a given one of the plurality of terminal contacts 804 is configured in an anchor slot 808 of a female element of the housing connector carrier 802.

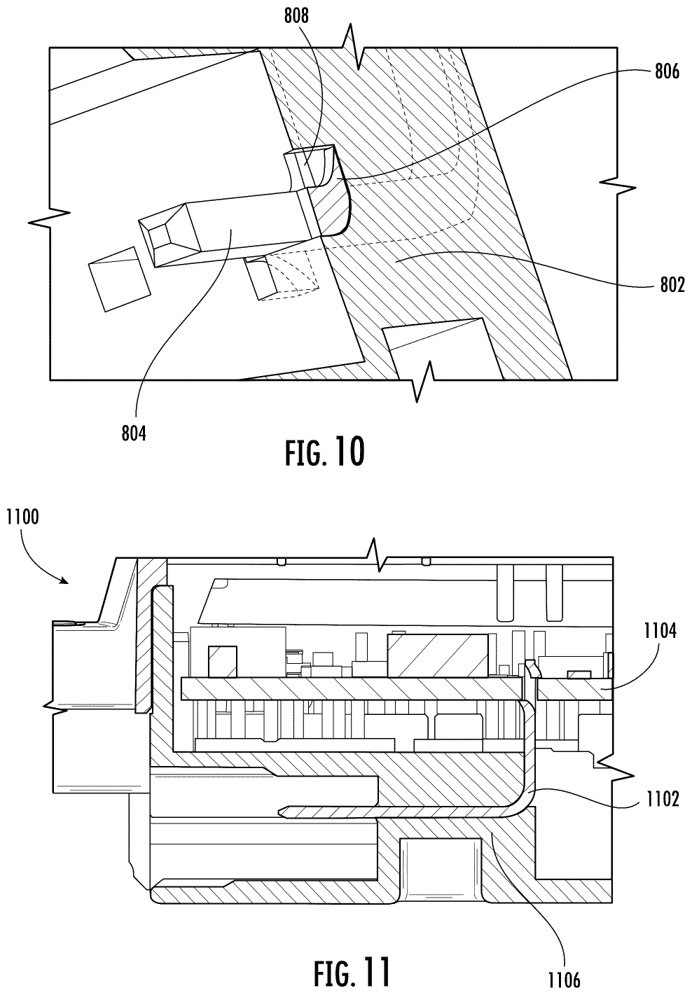

FIG. 10 is a zoomed-in view of an example anchor slot 808 in accordance with some embodiments of the present disclosure. The interface 806 is configured in the anchor slot 808 of a female element of the housing connector carrier 802 upon insertion of a given one of the plurality of terminal contacts 804 through the female element. The interface 806 may provide a locating and securing element such that the interface 806 may be fixed and/or secured in the anchor slot 808 to provide firm placement of the terminal contact 804 within the housing connector carrier 802. For example, the interface 806 may be allowed to engage with the anchor slot 808 by passing through the female element of housing connector carrier 802 in a first direction. As such, the interface 806 may be prevented from retreating out of the given female element in a second direction (e.g., removal) that is opposite of the first direction. In some embodiments, the second interface may be disengaged from the anchor slot 808 by deforming the interface 806 (e.g., the pair of anchor elements) in a manner to free the interface 806 from the anchor slot 808 thereby allowing removal of the terminal contact 804 from the housing connector carrier 802.

FIG. 11 is a cross-sectional view of an example configuration of a terminal contact 1102 with a PCBA 1104 within an example housing 1100 in accordance with some embodiments of the present disclosure. The terminal contact 1102 is an example of the terminal contact 500 of FIG. 5. The housing 1100 comprises a housing connector carrier 1106 that is configured with at least a portion (e.g., a second interface 504 at an intermediate portion of the shaft 506) of a terminal contact 1102 inserted therewith. A PCBA 1104 is further configured with terminal contact 1102.

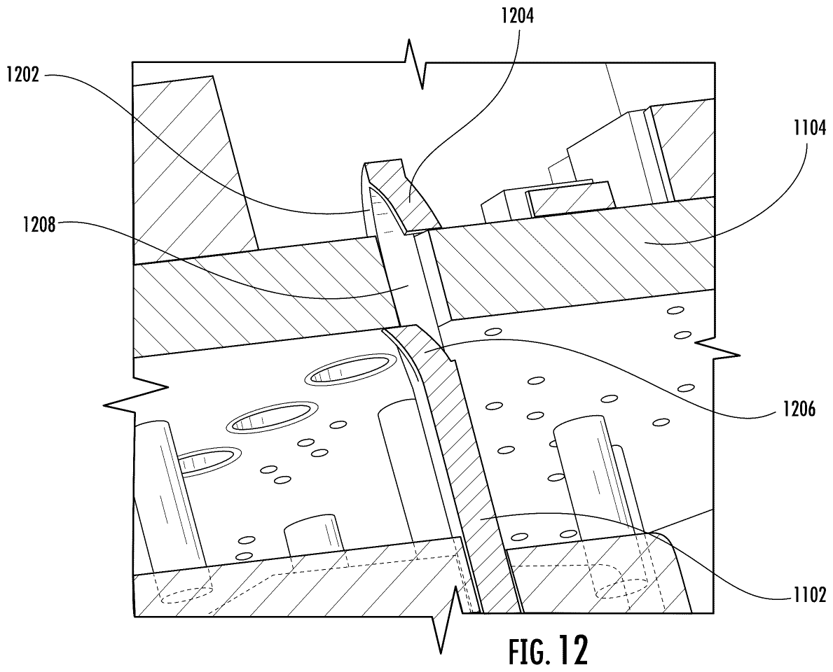

FIG. 12 depicts an example configuration of the PCBA 1104 with the terminal contact 1102 in accordance with some embodiments of the present disclosure. In some example embodiments, upon configuring at least a portion of a PCBA 1104 in an eye of needle 1208 between a first anchor element 1204 and a second anchor element 1206 of an interface 1202 (e.g., via insertion of at least a portion of the interface 1202 and/or the first anchor element 1204 through a contact aperture of the PCBA 1104 in a first direction along the plane of the interface 1202), the second anchor element 1206 may prevent the terminal contact 1102 from advancing further through at least the portion of the PCBA 1104 in the first direction along the plane of the interface 1202 while the first anchor element 1204 may prevent the terminal contact 1102 from returning through at least the portion of the PCBA 1104 in a second direction along the plane of the interface 1202 opposite of the first direction along the plane of the interface 1202. As such, the interface 1202 may provide the terminal contact 1102 with electrical, signal, and/or data connectivity to a PCBA 1104 without soldering or intricate pin design and locating.

It is to be understood that the disclosure is not to be limited to the specific embodiments disclosed, and that modifications and other embodiments are intended to be included within the scope of the appended claims. Although specific terms are employed herein, they are used in a generic and descriptive sense only and not for purposes of limitation, unless described otherwise.

What is claimed is:

1. A terminal contact comprising:
a shaft;
a first interface at a first end of the shaft, the first interface comprising an eye of needle, a first anchor element, and a second anchor element; and,
a second interface at an intermediate portion of the shaft, the second interface comprising a third anchor element and a fourth anchor element.

2. The terminal contact of claim 1, wherein the first interface is configured with a printed circuit board assembly.

3. The terminal contact of claim 1, wherein the eye of needle comprises two sidewalls that are compressible.

4. The terminal contact of claim 1, wherein at least one of the first anchor element or the second anchor element comprises a barb having an inclined plane shape.

5. The terminal contact of claim 1, wherein the first anchor element comprises a first barb that (i) allows for passing through an aperture from a first end of the first barb in a first direction that is along a plane of the first interface and (ii) prevents passing through the aperture at a second end of the first barb in a second direction along the plane of the first interface.

6. The terminal contact of claim 5, wherein the second anchor element comprises a second barb that prevents passing through the aperture at a first end of the second barb in the first direction along the plane of the first interface.

7. The terminal contact of claim 1, wherein the third anchor element comprises a barbed appendage that (i) is located on a first side of the shaft and (ii) comprises a shape that is arched towards a first direction away from a plane of the second interface.

8. The terminal contact of claim 7, wherein the fourth anchor element comprises a barbed appendage that (i) is located on a second side of the shaft that is opposite of the first side and (ii) comprises a shape that is arched towards a second direction away from the plane of the second interface.

9. The terminal contact of claim 1, wherein the second interface is configured with a female element of a housing connector carrier.

10. The terminal contact of claim 9, wherein the second interface is configured with the female element by (i) inserting a second end of the shaft that is opposite of the first end into the female element and (ii) passing the third anchor element and the fourth anchor element through the female element.

11. The terminal contact of claim 1, wherein the third anchor element and the fourth anchor element comprise locating elements for desired positioning of the shaft with respect to a female element.

12. The terminal contact of claim 1, wherein the female element comprises an anchor slot that is configured to receive the third anchor element and the fourth anchor element.

13. The terminal contact of claim 12, wherein the third anchor element and the fourth anchor element provide locking of the second interface into the anchor slot.

14. The terminal contact of claim 12, wherein the second interface is deformable for disengagement from the female element.

15. The terminal contact of claim 1, wherein the first interface provides electrical, signal, and/or data connectivity to a printed circuit board assembly.
